(19) United States
(12) Patent Application Publication
(10) Pub. No.: US 2018/0081111 A1
(43) Pub. Date: Mar. 22, 2018

(54) GLASS SHEET AND METHOD FOR MANUFACTURING GLASS SHEET

(71) Applicant: Asahi Glass Company, Limited, Chiyoda-ku (JP)

(72) Inventors: Naoaki MIYAMOTO, Chiyoda-ku (JP); Masabumi ITO, Chiyoda-ku (JP); Kazuya ISHIKAWA, Chiyoda-ku (JP); Kazuya TAKEMOTO, Chiyoda-ku (JP); Shigeki TAKANO, Chiyoda-ku (JP)

(73) Assignee: Asahi Glass Company, Limited, Chiyoda-ku (JP)

(21) Appl. No.: 15/804,247

(22) Filed: Nov. 6, 2017

Related U.S. Application Data
(63) Continuation of application No. PCT/JP2016/066845, filed on Jun. 7, 2016.

(30) Foreign Application Priority Data
Jun. 9, 2015 (JP) 2015-116706
Aug. 11, 2015 (JP) 2015-158842

(51) Int. Cl. F21V 8/00; C03C 3/087

(52) U.S. Cl. CPC G02B 6/0065; C03B 33/02; C03C 3/087; G02B 6/0043

(57) ABSTRACT

A glass sheet includes a first surface; a second surface facing the first surface; and at least one first edge surface disposed between the first surface and the second surface. A mean height We of a waviness profile element of the first edge surface and a mean length WSm of the waviness profile element satisfy Formula (1) below.

$${W}_{c} ≦ \frac{1}{0.6 {π}^{2} ( {n}_{g} - 1 )} \cdot {WSm}^{2} \qquad ( 1 )$$

where n_{g} represents a refractive index of the glass sheet.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2016/066845 filed on Jun. 7, 2016, and designating the U.S., which claims priority of Japanese Priority Application No. 2015-116706, filed on Jun. 9, 2015, and Japanese Priority Application No. 2015-158842, filed on Aug. 11, 2015. The entire contents of the foregoing applications are incorporated herein by reference.

### BACKGROUND OF THE INVENTION

### 1. Field of the Invention

The present invention relates to a glass sheet and a method for manufacturing the glass sheet.

### 2. Description of the Related Art

In recent years, liquid crystal displays are installed in mobile information terminals represented by liquid crystal televisions, tablet terminals, and smart phones. A liquid crystal display includes a surface-shaped light-emitting device as a back light, and a liquid crystal panel placed on the light-emitting surface side of this surface-shaped light-emitting device.

Such a surface-shaped light-emitting device may be of the direct-lit type or the edge-lit type, where the edge-lit type is frequently used such that the light source can be made smaller. An edge-lit, surface-shaped light-emitting device includes a light source, a light-guiding plate, a reflective sheet, and a diffusion sheet.

Light from the light source is incident on a light-incident edge surface (also referred to as a “light-incident surface”, simply) foamed on a side surface of the light-guiding plate to enter the inside of the light-guiding plate. The light-guiding plate has multiple reflective dots formed on a light-reflective surface, which is a surface on the side opposite to a light-emitting surface that faces the liquid crystal panel. The reflective sheet is placed so as to face the light-reflective surface, and the diffusion sheet is placed so as to face the light-emitting surface.

Light incident on the light-guiding plate from the light source is reflected by the reflective dots and the reflective sheets, to be emitted from the light-emitting surface. The light emitted from this light-emitting surface is diffused by the diffusion sheet, and then, is incident on the liquid crystal panel.

As a material of this light-guiding plate, a glass sheet having a high transmittance and a superior heat resistance may be used (see Japanese Laid-open Patent Publication No. 2013-093195 and Japanese Laid-open Patent Publication No. 2013-030279).

If using a glass sheet as the light-guiding plate, it is arranged so that a cut surface of the glass sheet (an edge surface) serves as the light-incident edge surface. Here, dependent on a state of the cut surface, a phenomenon occurs in that the brightness of the light emitted in the light-emitting surface varies depending on the spot (referred to as “non-uniform brightness”, below), which may lead to a problem of degradation of optical characteristics.

In order to prevent the problem of non-uniform brightness of the light-emitting surface, it has been considered to process the light-incident edge surface. However, conventionally, sufficient consideration has not been made in terms of obtaining a surface state of the light-incident edge surface to inhibit the non-uniform brightness of the light-emitting surface.

### SUMMARY OF THE INVENTION

According to an aspect of the present invention, a glass sheet includes a first surface; a second surface facing the first surface; and at least one first edge surface disposed between the first surface and the second surface, wherein a mean height We of a waviness profile element of the first edge surface and a mean length WSm of the waviness profile element satisfy Formula (1) below.

$${W}_{c} ≦ \frac{1}{0.6 {π}^{2} ( {n}_{g} - 1 )} \cdot {WSm}^{2} \qquad ( 1 )$$

where n_{g} represents a refractive index of the glass sheet.

According to another aspect of the present invention, a glass sheet includes a first surface; a second surface facing the first surface; and at least one first edge surface disposed between the first surface and the second surface, wherein representing a periodic structure of the first edge surface by a power spectrum distribution, a shape of the power spectrum has a maximum peak position Sₚ less than 1 mm⁻¹ within a range of a spatial frequency being 0.01 to 10 mm⁻¹.

Other objects, features, and advantages of the present invention will become more apparent from the following detailed description when read in conjunction with the accompanying drawings.

### BRIEF DESCRIPTION OF THE DRAWINGS

FIG. 1 is a schematic configuration diagram illustrating a liquid crystal display that uses a glass sheet as a light-guiding plate according to an embodiment;

FIG. 2 is a diagram illustrating a light-reflective surface of a light-guiding plate;

FIG. 3 is a perspective view of a light-guiding plate;

FIG. 4 is a diagram for illustrating chamfers formed on a light-guiding plate;

FIG. 5 is a process chart of a method for manufacturing a glass sheet according to an embodiment;

FIG. 6 is a diagram for illustrating a cutting structure obtained by a method for manufacturing a glass sheet according to an embodiment;

FIG. 7 is a diagram for illustrating a specularization treatment process;

FIG. 8 is a diagram illustrating a relationship among the mean height We of a waviness profile element of a light-incident edge surface, the mean length WSm of the waviness profile element, and the focal length of parallel light from a light source;

FIGS. 9A-9E are diagrams illustrating power spectrum distributions of light-incident edge surfaces of samples 1-5, respectively; and

FIGS. 10F-10I are diagrams illustrating power spectrum distributions of light-incident edge surfaces of samples 6-9, respectively.

### DESCRIPTION OF THE PREFERRED EMBODIMENTS

Next, embodiments will be described with reference to the drawings, which are examples not intended to limit the present invention.

According to an aspect of the present invention, it is possible to provide a glass sheet that can inhibit the non-uniform brightness when used as the light-guiding plate, and a method for manufacturing the glass sheet. Note that the same or corresponding numerical codes are assigned to the same or corresponding members or parts throughout the drawings, to omit duplicated description. Also, unless especially specified, it is not an object of the drawings to show relative ratios among members or parts. Therefore, specific dimensions may be determined by one skilled in the art with reference to the following non-limiting embodiments. Also, the embodiments described in the following do not limit the invention, but are examples, and not all features and their combinations described in the embodiments are necessarily essential to the invention.

<Liquid Crystal Display>

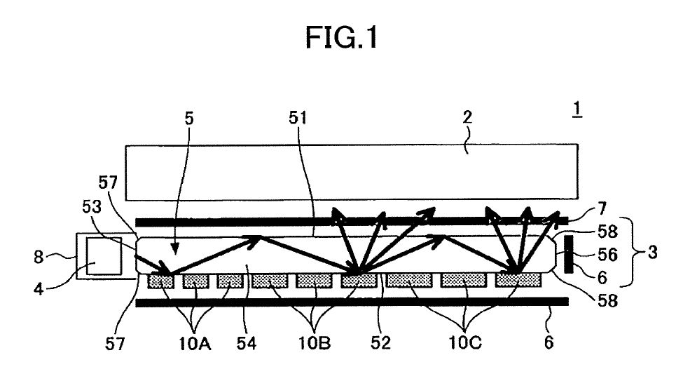

FIG. 1 illustrates a liquid crystal display 1 that uses a glass sheet according to an embodiment of the present invention. The liquid crystal display 1 is installed in an electronic device, for example, a mobile information terminal designed to be smaller and thinner. The liquid crystal display 1 includes a liquid crystal panel 2 and a surface-shaped light-emitting device 3.

The liquid crystal panel 2 has an alignment layer, a transparent electrode, a glass substrate, and a polarizing filter stacked so as to sandwich the liquid crystal layer disposed at the center. Also, a color filter is placed on one side of the liquid crystal layer. Molecules of the liquid crystal layer rotate around alignment axes in response to a drive voltage applied to the transparent electrode, by which displaying is executed in a predetermined way.

The edge-lit type is adopted for the surface-shaped light-emitting device 3 to realize a smaller size and a thinner profile. The surface-shaped light-emitting device 3 includes a light source 4, a light-guiding plate 5, a reflective sheet 6, a diffusion sheet 7, and reflective dots 10A-10C. Light incident on the light-guiding plate 5 from the light source 4 travels while being reflected by the reflective dots 10A-10C and the reflective sheet 6, and is emitted from the light-emitting surface 51 that faces the liquid crystal panel 2 of the light-guiding plate 5. The light emitted from this light-emitting surface 51 is diffused by the diffusion sheet 7, and then, is incident on the liquid crystal panel 2. In addition, in order to improve the incidence efficiency of the light radially emitted from the light source 4 to be incident on the light-guiding plate 5, a reflector 8 is provided on the back surface side of the light source 4.

The light source 4 is not limited particularly, and a hot cathode tube, a cold cathode tube, or an LED (Light Emitting Diode) may be used. This light source 4 is placed so as to face the light-incident edge surface 53 of the light-guiding plate 5.

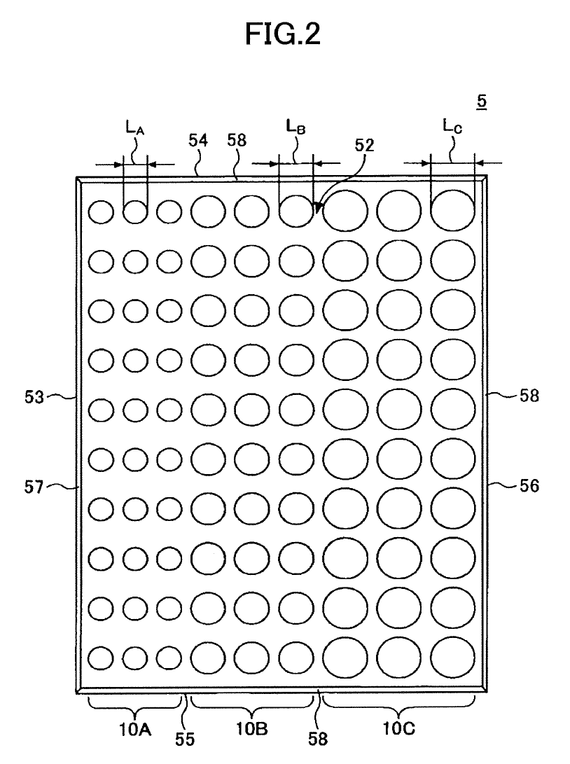

The reflective sheet 6 is a film made of a light reflective member formed on the surface of a resin sheet such as an acrylic resin. This reflective sheet 6 may be foamed on a light-reflective surface 52 and non-light-incident edge surfaces 54, 55, and 56 of the light-guiding plate 5. The light-reflective surface 52 is a surface that faces the light-emitting surface 51 of the light-guiding plate 5. The non-light-incident edge surfaces 54-56 are the edge surfaces of the light-guiding plate 5 other than the light-incident edge surface 53. It is preferable to dispose the reflective sheet 6 at least on the non-light-incident edge surface 56 that faces the light-incident edge surface 53. This enables light incident on the light-incident edge surface 53 to travel in the traveling direction of the light (traveling rightward in FIG. 1 and FIG. 2) while being reflected inside the light-guiding plate 5, and when reaching the non-light-incident edge surface 56, to be reflected inward toward the light-guiding plate 5 again by the reflective sheet 6. More preferably, the reflective sheet 6 may also be disposed on the non-light-incident edge surfaces 54 and 55. This enables light scattered inside the light-guiding plate 5 and reaching the non-light-incident edge surfaces 54 and 55, to be reflected inward toward the light-guiding plate 5 again by the reflective sheet 6. Other than using the reflective sheet 6, reflective films may be formed on the light-reflective surface 52 and the non-light-incident edge surfaces 54-56 of the light-guiding plate 5 by printing or the like.

The material of the resin sheet constituting the reflective sheet 6 is not limited to an acrylic resin, and other materials, for example, a polyester resin such as a PET resin, a urethane resin, and a combination of these may be used. As the light reflex member constituting the reflective sheet 6, for example, a metal vapor deposition film may be used.

It is preferable for the reflective sheet 6 disposed on the non-light-incident edge surfaces 54-56 to be provided with an adhesive. As the adhesive provided on the reflective sheet 6, it is possible to use, for example, an acrylic resin, a silicone resin, a urethane resin, a synthetic rubber, or the like. The thickness of the reflective sheet 6 is not limited particularly, and may be, for example, 0.01 to 0.50 mm.

For the diffusion sheet 7, a film made of an acrylic resin having a milky white color may be used. Since the diffusion sheet 7 diffuses the light emitted from the light-emitting surface 51 of the light-guiding plate 5, it is possible to irradiate the back surface side of the liquid crystal panel 2 with uniform light free of non-uniform brightness. Note that the reflective sheet 6 and the diffusion sheet 7 are fixed to predetermined positions of the light-guiding plate 5 by adhesion.

<Glass Sheet and Glass Light-Guiding Plate>

Next, a glass sheet used as the light-guiding plate 5, and the light-guiding plate 5 will be described.

The light-guiding plate 5 is constituted with a glass sheet having a high transparency. In the embodiment, multi-component oxide glass is used as the material of the glass sheet used as the light-guiding plate 5. As illustrated in FIG. 2 to FIG. 5 in addition to FIG. 1, this light-guiding plate 5 includes a light-emitting surface 51 (a first surface), the light-reflective surface 52 (a second surface), a light-incident edge surface 53 (a first edge surface), the non-light-incident edge surfaces 54-56 (second edge surfaces), chamfer surfaces on the light-incident side 57 (first chamfer surfaces), and chamfer surfaces on the non-light-incident side 58 (second chamfer surfaces).

The light-emitting surface 51 is a surface that faces the liquid crystal panel 2. In the embodiment, the light-emitting surface 51 is formed to have a rectangular shape in a planar view (viewing the light-emitting surface 51 from the above). However, the shape of the light-emitting surface 51 is not limited as such. The size of this light-emitting surface 51 is determined in accordance with the liquid crystal panel 2, and is not limited particularly. In the embodiment, the size of the light-emitting surface 51 is set to be 200 to 1200 mm by 100 to 700 mm.

The light-reflective surface 52 is a surface that faces the light-emitting surface 51. The light-reflective surface 52 is configured to be parallel with the light-emitting surface 51. Also, the light-reflective surface 52 is configured to have the same shape and size as the light-emitting surface 51. However, the light-reflective surface 52 does not necessarily need to be parallel with the light-emitting surface 51, and may be configured to include a step or an inclination. Also, the size of the light-reflective surface 52 may be different from the size of the light-emitting surface 51.

As illustrated in FIG. 2, the reflective dots 10A-10C are formed on the light-reflective surface 52. These reflective dots 10A-10C are formed by printing white ink to have dot shapes. The brightness of the light incident on the light-incident edge surface 53 is high, and the brightness decreases while being reflected and traveling in the light-guiding plate 5. Therefore, in the embodiment, the size of the reflective dots 10A-10C are made different along the traveling direction of the light (traveling rightward in FIG. 1 and FIG. 2) from the light-incident edge surface 53. Specifically, the diameter (L_{A}) of a reflective dot 10A in an area close to the light-incident edge surface 53 is set small, and the diameter (L_{B}) of a reflective dot 10B and the diameter (L_{C}) of a reflective dot 10C are set greater in the traveling direction of the light (L_{A}<L_{B}<L_{C}). In this way, by changing the size of the reflective dots 10 in the traveling direction of the light in the light-guiding plate 5, it is possible to make uniform the brightness of the emitted light emitted from the light-emitting surface 51, and to prevent occurrence of the non-uniform brightness. Note that instead of changing the size of the reflective dots 10, the same effect may be obtained by changing the number density of the reflective dots 10 in the traveling direction of the light in the light-guiding plate 5. Alternatively, instead of the reflective dots 10, the same effect may be obtained by forming grooves on the light-reflective surface 52 to reflect the incident light; by adhering a transparent resin sheet having the reflective dots 10 printed to the light-guiding plate 5; or by laying a transparent resin sheet having the reflective dots 10 printed on the light-guiding plate 5.

In the embodiment, four edge surfaces are formed between the light-emitting surface 51 and the light-reflective surface 52. Among the four edge surfaces, the light-incident edge surface 53, which is the first edge surface, is a surface on which the light from the light source 4 is incident. The non-light-incident edge surfaces 54-56, which are the second to fourth edge surfaces, are surfaces on which light from the light source 4 is not incident.

<Light-Incident Edge Surface>

The light-incident edge surface 53 is preferably a specular surface. In the embodiment, the mean height We (unit: μm) of a waviness profile element of the light-incident edge surface 53 and the mean length WSm (unit: mm) of the waviness profile element satisfy the following relational expression (1), where n_{g} represents the refractive index of the glass sheet, which is generally n_{g}=1.4 to 1.6, for example, n_{g}=1.55; and n is the circular constant. The mean length WSm of a waviness profile element represents a mean length of the waviness profile element according to JIS B 0601:2013. The mean height Wc of a waviness profile element represents a mean height of the waviness profile element according to JIS B 0601:2013.

If satisfying the relational expression (1), parallel light incident on the light-incident edge surface does not come into focus within a distance of 300 mm or closer from the light-incident edge surface. Since the brightness becomes particularly higher at the focal position, non-uniform brightness would occur in the surface of the glass sheet which is the light-guiding plate 5. Therefore, by not having the focus come within the distance of 300 mm from the light-incident edge surface, it is possible to inhibit the non-uniform brightness. The basis of Formula (1) will be described later with application examples.

$${W}_{c} ≦ \frac{1}{0.6 {π}^{2} ( {n}_{g} - 1 )} \cdot {WSm}^{2} \qquad ( 1 )$$

In the embodiment, it is preferable that the arithmetic mean waviness Wa of the light-incident edge surface 53 is 0.2 μm or less. Accordingly, it is possible to inhibit the non-uniform brightness of the light incident on the light-guiding plate 5 from the light source 4. The arithmetic mean waviness Wa of the light-incident edge surface 53 is more preferably 0.1 μm or less, furthermore preferably 0.08 μm or less, and particularly preferably 0.06 μm or less. The arithmetic mean waviness Wa represents an arithmetic mean waviness according to JIS B 0601:2013.

The mean height Wc of the waviness profile element of the light-incident edge surface 53, the mean length WSm of the waviness profile element of the light-incident edge surface 53, and the arithmetic mean waviness Wa of the light-incident edge surface 53 can be measured by using a surface roughness and contour measuring instrument called “Surfcom 1400D” (manufactured by Tokyo Seimitsu Co., Ltd.), to scan the light-incident edge surface 53 under the following measurement conditions.

Cutoff value: λ_{c}=0.25 mm and λ_{f}=2.5 mm
Scanning rate: 0.3 mm/sec
Measurement length: 5λ_{f}

The periodic structure of the light-incident edge surface 53 can be represented in a power spectrum by using Fourier transform. In this case, the shape of the power spectrum of the periodic structure of the light-incident edge surface 53 has the maximum peak position Sₚ less than 1 mm⁻¹ within a range of the spatial frequency being 0.01 to 10 mm⁻¹. If the shape of the power spectrum of the periodic structure of the light-incident edge surface 53 satisfies the above conditions, a waviness component having a smaller period, namely, having a greater WSm becomes dominant, and the non-uniform brightness of the light incident on the light-guiding plate 5 from the light source 4 is inhibited. The maximum peak position Sₚ is preferably less than 0.9 mm⁻¹, and more preferably less than 0.8 mm⁻¹. Note that if the value of the power spectrum at a position of 0.01 mm⁻¹ of the spatial frequency is greater than or equal to a maximum peak intensity Iₛ within a range of the spatial frequency being 1 to 10 mm⁻¹, which will be described later, the maximum peak position Sₚ is considered to be 0.01 mm⁻¹.

Besides, it is preferable that the shape of the power spectrum has Iₛ/Iₚ, which is a ratio of the maximum peak intensity Iₛ within a range of the spatial frequency being 1 to 10 mm⁻¹, to the peak intensity Iₚ at the maximum peak position Sₚ, being 50% or less. Note that Iₛ/Iₚ is 100% if Sₚ is 1 mm⁻¹ or greater. If the above conditions of the shape of the power spectrum of the periodic structure of the light-incident edge surface 53 are satisfied, a waviness component having a greater period, namely, having a smaller WSm becomes dominant, and the non-uniform brightness of the light incident on the light-guiding plate 5 from the light source 4 is inhibited. Iₛ is preferably 40% or less, and more preferably 30% or less.

The shape of the power spectrum of the periodic structure of the light-incident edge surface 53 can be measured by using the surface roughness and contour measuring instrument called “Surfcom 1400D” (manufactured by Tokyo Seimitsu Co., Ltd.), to scan the light-incident edge surface 53 under the following measurement conditions.

Cutoff value: λ_{c}=0.25 mm and λᵣ=2.5 mm
Scanning rate: 0.3 mm/sec
Measurement length: 5λ_{f}

It is preferable that the maximum height Pz of the cross-sectional profile of the light-incident edge surface 53 is 300 μm or less. Accordingly, the distance between the light-incident edge surface 53 and the light source 4 can be contained within a certain range, and thereby, it is possible to inhibit non-uniform brightness of the light incident on the light-guiding plate 5 in a direction parallel to the light-incident edge surface 53. The maximum height Pz of the cross-sectional profile of the light-incident edge surface 53 is preferably 250 μm or less, and more preferably 200 μm or less. Note that the maximum height Pz of the cross-sectional profile represents a maximum height of the cross-sectional profile according to JIS B 0601:2013.

The maximum height Pz of the cross-sectional profile of the light-incident edge surface 53 can be measured by using the surface roughness and contour measuring instrument called “Surfcom 1400D” (manufactured by Tokyo Seimitsu Co., Ltd.), to scan the light-incident edge surface 53 under the following measurement conditions.

Cutoff value: unspecified
Scanning rate: 3 mm/sec
Measurement length: 300 mm

It is preferable that the arithmetic mean roughness Ra of the surface of the light-incident edge surface 53 is 0.03 μm or less. Accordingly, it is possible to improve the light incident efficiency of the light incident on the light-guiding plate 5 from the light source 4. The arithmetic mean roughness Ra of the light-incident edge surface 53 is preferably 0.01 μm or less, and more preferably 0.005 μm or less. This improves the light incident efficiency of the light that is incident on the light-guiding plate 5 from the light source 4. Note that the notation of the arithmetic mean roughness Ra represents an arithmetic mean roughness according to JIS B 0601:2013.

The arithmetic mean roughness Ra of the light-incident edge surface 53 can be measured by using the surface roughness and contour measuring instrument called “Surfcom 1400D” (manufactured by Tokyo Seimitsu Co., Ltd.), to scan the light-incident edge surface 53 under the following measurement conditions.

Cutoff value: λ_{c}=0.25 mm
Scanning rate: 0.3 mm/sec
Measurement length: 5λ_{c}

The width dimension W of the light-incident edge surface 53 (see FIG. 4) is set to a width dimension required by the liquid crystal display 1 having the surface-shaped light-emitting device 3 installed.

<Non-Light-Incident Edge Surface>

Since the light from the light source 4 is not incident on the non-light-incident edge surfaces 54-56, these surfaces may not need to be processed as highly precisely as the surface of the light-incident edge surface 53; however, the surfaces of the non-light-incident edge surfaces 54-56 may have an arithmetic mean roughness Ra comparable with that of the light-incident edge surface 53. It is preferable that the arithmetic mean roughness Ra of the non-light-incident edge surfaces 54-56 is 0.8 μm or less. If the arithmetic mean roughness Ra of the non-light-incident edge surfaces 54-56 is 0.8 μm or less, the adhesiveness of the reflective sheet 6 to the non-light-incident edge surfaces 54-56 becomes better. The arithmetic mean roughness Ra of the non-light-incident edge surfaces 54-56 is preferably 0.4 μm or less, more preferably 0.2 μm or less, even more preferably 0.1 μm or less, and particularly preferably 0.04 μm or less. The arithmetic mean roughness Ra of the non-light-incident edge surfaces 54-56 can be measured by the same method as the measuring method of the arithmetic mean roughness of the light-incident edge surface 53 described above.

Also, in the embodiment, a grinding process and a polishing process may not be, or may be applied to the non-light-incident edge surfaces 54-56. If neither a grinding process nor a polishing process is applied to the non-light-incident edge surfaces 54-56, the arithmetic mean roughness Ra of the non-light-incident edge surfaces 54-56 can be greater than the arithmetic mean roughness Ra of the light-incident edge surface 53; the arithmetic mean roughness Ra of the non-light-incident edge surfaces 54-56 is preferably 0.01 μm or greater, and more preferably 0.03 μm or greater. Accordingly, compared with the light-incident edge surface 53, processing the non-light-incident edge surfaces 54-56 becomes easier or unnecessary, and hence, the productivity improves. If a grinding process or a polishing process is applied to the non-light-incident edge surfaces 54-56, the arithmetic mean roughness Ra of the non-light-incident edge surface 53 is preferably 0.03 μm or less, more preferably 0.01 μm or less, and even more preferably 0.005 μm or less. Note that as for the non-light-incident edge surfaces 54-56, surfaces to which cutting has been applied may be used as the non-light-incident edge surfaces 54-56 as they are.

Now, representing the width dimension of the non-light-incident edge surfaces 54-56 (namely, a dimension in the sheet thickness direction of a part of the surfaces disposed between the first surface and the second surface except for the chamfer surfaces on the non-light-incident side, which will be described later) by L mm, as illustrated in FIG. 4, the average Lₐᵥₑ of this width dimension L in the longitudinal direction of the chamfer surfaces (simply referred to as “the longitudinal direction”, below) is 0.25 to 9.8 mm. It is preferable that Lₐᵥₑ is 0.50 to 9.8 mm. If Lₐᵥₑ is 9.8 mm or less, the width dimension of the chamfer surfaces on the non-light-incident side 58 can be sufficiently secured. If Lₐᵥₑ is 0.25 mm or greater, it is possible to decrease an error of L, which will be described later.

In the width dimension of the non-light-incident edge surfaces 54-56, error occurs in practice in the longitudinal direction, which originates from unevenness in processing when executing a cutting process and/or a chamfering process. Representing the average of the width dimension L in the longitudinal direction of the non-light-incident edge surfaces 54-56 by Lₐᵥₑ mm, it is preferable that an error of L with respect to Lₐᵥₑ in the longitudinal direction is within 50% of Lₐᵥₑ. In other words, representing the maximum of L in the longitudinal direction by Lₑₓ mm and the minimum by Lₘᵢₙ mm, it is preferable to satisfy Iₘₐₓ≦1.5×Lₐᵥₑ and Lₘᵢₙ×Lₐᵥₑ. It is more preferable within 40%, even more preferable within 30%, or particularly preferable within 20%. This makes an error of the width dimension of the non-light-incident edge surfaces 54-56 in the longitudinal direction smaller, and hence, it is possible to decrease the non-uniform brightness occurring when light reflects on the reflective sheet 6 in the light-guiding plate 5.

<Chamfer Surface on Light-Incident Side>

Between the light-emitting surface 51 and the light-incident edge surface 53, and between the light-reflective surface 52 and the light-incident edge surface 53, the chamfer surfaces on the light-incident side 57 are formed. In the embodiment, the illustrated example has the chamfer surfaces on the light-incident side 57 formed both between the light-reflective surface 52 and the light-incident edge surface 53, and between the light-emitting surface 51 and the light-incident edge surfaces 53; however, a configuration may be adopted in which the chamfer surface on the light-incident side 57 is provided at one of the locations.

For the surface-shaped light-emitting device 3 required to be smaller and thinner as in the embodiment, the thickness of the light-guiding plate 5 needs to be thinner. Therefore, the thickness of the light-guiding plate 5 according to the embodiment is 10 mm or less. However, if a configuration is adopted that does not provide the chamfer surfaces on the light-incident side 57 in the light-guiding plate 5, but includes angular parts, when assembling the surface-shaped light-emitting device 3 to have the light-guiding plate 5 attached, there is a possibility that the angular parts may contact other structural components and may be damaged, and the strength of the light-guiding plate 5 may decrease. Therefore, the light-guiding plate 5 according to the embodiment has the thickness of 0.5 mm or greater, and further, has the chamfer surfaces on the light-incident side 57 formed on the upper edge and the lower edge of the light-incident edge surface 53.

In order to improve the light incident efficiency of the light from the light source 4 on the light-guiding plate 5, it is necessary to widen the light-incident edge surface 53. Therefore, it is preferable that the chamfer surface on the light-incident side 57 is smaller, and accordingly, chamfering is applied in the embodiment so as to form the chamfer surface on the light-incident side 57.

Now, representing the width dimension of the chamfer surface on the light-incident side 57 (a chamfer surface) by X mm, the average Xₐᵥₑ of the width dimension X in the longitudinal direction of the chamfer surface (simply referred to as “the longitudinal direction”, below) illustrated in FIG. 4 is 0.1 mm. It is preferable that Xₐᵥₑ is 0.1 mm to 0.5 mm. If Xₐᵥₑ is 0.5 mm or less, it is possible to widen the width dimension W of the light-incident edge surface 53. If Xₐᵥₑ is 0.1 mm or greater, it is possible to make an error of X, which will be described later, smaller.

In the width dimension of the chamfer surface on the light-incident side 57, error occurs in practice in the longitudinal direction, which originates from unevenness in processing when executing a cutting process and/or a chamfering process. In FIG. 4, an error of the width dimension X of the chamfer surface on the light-incident side 57 is 0.05 mm or less. In this way, when representing the average of the width dimension X in the longitudinal direction of the chamfer surface on the light-incident side 57 by Xₐᵥₑ mm, it is preferable that an error in the longitudinal direction of X is within 50% of Xₐᵥₑ. In other words, X satisfies 0.5Xₐᵥₑ≦X≦1.5Xₐᵥₑ. It is more preferable within 40%, even more preferable within 30%, and particularly preferable within 20%. This makes an error of the width dimension of the chamfer surface on the light-incident side 57 in the longitudinal direction and the width dimension of the light-incident edge surface 53 smaller, and thereby, it is possible to make the non-uniform brightness occurring in the light-guiding plate 5 smaller.

Also, the arithmetic mean roughness Ra of the chamfer surface on the light-incident side 57 is set to be 0.8 μm or less. By having the arithmetic mean roughness Ra of the chamfer surface on the light-incident side 57 less than or equal to 0.8 μm, it is possible to limit the amount of cullet generated in a grinding process and a polishing process, and the non-uniform brightness of the light-guiding plate 5 occurs less frequently. A greater width dimension X of the chamfer surface on the light-incident side 57 increases the amount of generated cullet; thus, it is preferable that the arithmetic mean roughness Ra of the chamfer surface on the light-incident side 57 is 0.4 μm or less, more preferably 0.3 μm or less, even more preferably is 0.1 μm or less, and particularly preferably 0.03 μm or less.

<Chamfer Surface on Non-Light-Incident Side>

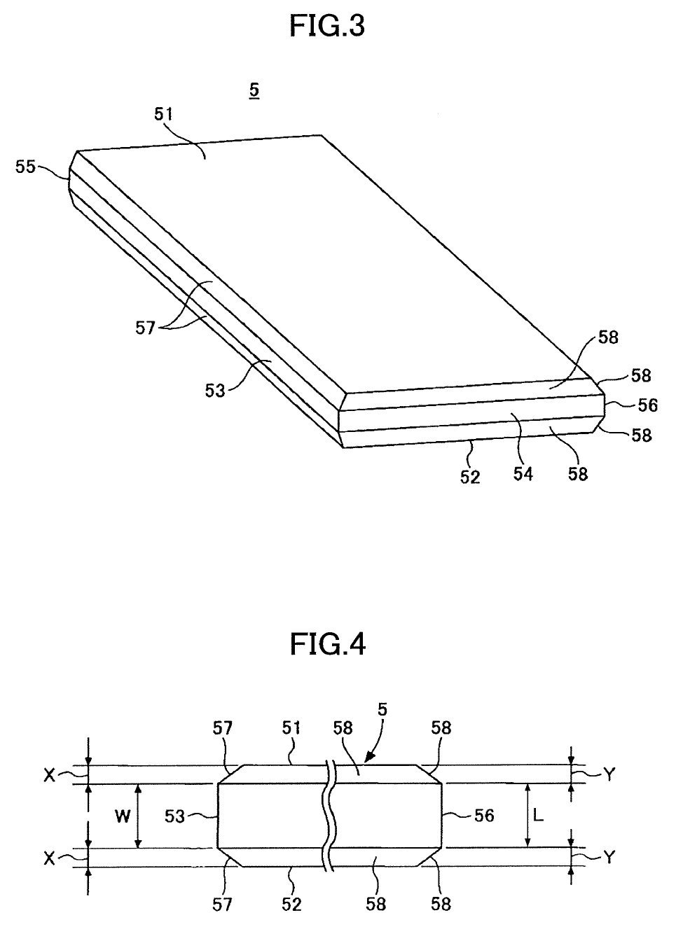

Also, in the embodiment, as illustrated in FIG. 3, the chamfer surfaces on the non-light-incident side 58 are formed at all locations between the light-emitting surface 51 and the non-light-incident edge surface 54; between the light-reflective surface 52 and the non-light-incident edge surface 54; between the light-emitting surface 51 and the non-light-incident edge surface 55; between the light-reflective surface 52 and the non-light-incident edge surface 55; between the light-emitting surface 51 and the non-light-incident edge surface 56; and between the light-reflective surface 52 and the non-light-incident edge surface 56. However, all of the above chamfer surfaces on the non-light-incident side 58 do not necessarily need to be formed, and the chamfer surfaces on the non-light-incident side 58 may be formed selectively.

Now, representing the width dimension of the chamfer surface on the non-light-incident side 58 by Y mm, as illustrated in FIG. 4, the average Yₐᵥₑ of the width dimension Y in the longitudinal direction of the chamfer surface is set to be Yₐᵥₑ=0.1 to 0.6 mm. If Yₐᵥₑ is 0.6 mm or less, it is possible to widen the width dimension of the non-light-incident edge surfaces 54-56. If Yₐᵥₑ is 0.1 mm or greater, it is possible to make an error of Y, which will be described later, smaller.

In the width dimension Y of the chamfer surface on the non-light-incident side 58, error occurs in the longitudinal direction, which originates from unevenness in processing when executing a chamfering process. When representing the average in the longitudinal direction of Y by Yₐᵥₑ mm, it is preferable that an error in the longitudinal direction of Y is within 50% of Yₐᵥₑ. In other words, Y satisfies 0.5Yₐᵥₑ≦Y≦1.5Yₐᵥₑ. It is more preferable within 40%, even more preferable within 30%, and particularly preferable within 20%. This makes an error smaller in the longitudinal direction of the width dimension of the non-light-incident edge surfaces 54-56 on which the incidence light is reflected, and thereby, it is possible to make the non-uniform brightness occurring in the light-guiding plate 5 smaller.

Also, the arithmetic mean roughness Ra of the chamfer surface on the non-light-incident side 58 is greater than the arithmetic mean roughness Ra the chamfer surface on the light-incident side 57 from the viewpoint of productivity improvement, and is set to be 0.4 μm or greater preferably. Besides, the arithmetic mean roughness Ra of the chamfer surface on the non-light-incident side 58 is set to be 1.0 μm or less preferably. Furthermore, the arithmetic mean roughness Ra of the chamfer surface on the non-light-incident side 58 being greater than or equal to 0.4 μm and less than or equal to 1.0 μm makes the adhesiveness between the reflective sheet 6 and the chamfer surface on the non-light-incident side 58 better when adhered together. Alternatively, the arithmetic mean roughness Ra of the chamfer surface on the non-light-incident side 58 may be equivalent to, or less than or equal to the arithmetic mean roughness Ra of the chamfer surface on the light-incident side 57. In this case, the arithmetic mean roughness Ra of the chamfer surface on the non-light-incident side 58 is set to be 0.8 μm or less.

<Optical Characteristics of Glass Sheet>

Under a condition of the optical path length being 200 mm, it is preferable that the glass sheet in the embodiment has the minimum of the internal transmittance being 80% or greater in a range of wavelengths from 400 to 700 nm, and the difference between the maximum and the minimum of the internal transmittance is 15% or less.

Here, the “optical path length” represents a distance from a surface on which light is incident, to a surface on the opposite side. The internal transmittance T (%) of single-wavelength light having the wavelength A (nm) through a glass sheet having the optical path length of 200 mm can be measured as follows. First, the glass sheet is cut to have the optical path length of 200 mm, and a surface on which single-wavelength light is incident, and a facing surface from which the light is emitted is polished so that the surface roughness Ra of the respective surfaces becomes 0.03 nm or less. Next, using a UV-visible-NIR spectrophotometer UH4150 (manufactured by Hitachi High-Technologies Corp.), single-wavelength light is emitted to be perpendicularly incident on the polished surface, for each of the wavelengths λ=400 to 700 nm by units of 1 nm, to measure the intensity of the emitted single-wavelength light for each of the wavelengths A. Based on a relational expression of T=I/I₀×100 where I₀ represents the intensity of the incidence light, and I represents the intensity of the emitted light, the internal transmittance T is calculated for each of the wavelengths λ. It is more preferable that the minimum of the internal transmittance is 85% or greater, and even more preferable to be 90% or greater, 95% or greater, 97% or greater, and 99% or greater. It is more preferable that the difference between the maximum and the minimum of the internal transmittance is 13% or less, and even more preferable to be 10% or less, 8% or less, and 5% or less.

Besides, under a condition of the optical path length being 50 mm, it is preferable that the glass sheet in the embodiment has the minimum of the internal transmittance being 90% or greater in the range of wavelengths from 400 to 700 nm. The transmittance for the 50-mm length is measured in a sample A, which is obtained by cutting a glass sheet 12 at the center part of the glass sheet in the direction perpendicular to the principal plane with the dimensions of 50 mm long and 50 mm wide, and by processing the first and second cut surfaces facing each other to have the arithmetic mean roughness Ra≦0.03 μm. Measurement is done by using a spectrophotometer that is capable of measurement for a 50-mm length (for example, UH4150 manufactured by Hitachi High-Technologies Corp.), for the 50-mm length of the sample A from the first cut surface in the normal direction, and by making the beam width of the incidence light narrower than the sheet thickness by a slit or the like. Then, loss by reflection on the surface is removed from the transmittance of the 50-mm length obtained in this way, to obtain the internal transmittance of the 50-mm length. It is preferable that the average internal transmittance of the 50-mm length for the wavelengths of 400-700 nm is 92% or greater, more preferably 95% or greater, even more preferably 98% or greater, and particularly preferably 99% or greater.

It is preferable that the glass sheet in the embodiment has the absorption index of light having the wavelength of 550 nm being 1 m⁻¹ or less. The absorption index of light having the wavelength of 550 nm is adopted as a determination indicator because the absorption index of light having the wavelength of 550 nm is generally the highest among light in the range of wavelengths 400 to 700 nm. Accordingly, light absorption is insignificant for three colors of R (red), G (green), and B (blue), which are used as the light source of a liquid crystal television whose surface-shaped light-emitting device is of the edge-lit type.

Here, the absorption index α (mm⁻¹) of a glass sheet for light at a wavelength λ (nm) is defined by a relational expression of α=−1/L×ln(T/100)=−1/L×ln(I/I₀), based on a measurement result of the internal transmittance T (%) in an optical path length L (mm). It is more preferable that the glass sheet in the embodiment has the maximum αₘₐₓ of the absorption index of light in the range of wavelengths 400 to 700 nm being 1 m⁻¹ or less, and even more preferable 0.7 m⁻¹ or less, 0.5 m⁻¹ or less.

Besides, it is preferable that a ratio (αₘₐₓ/αₘᵢₙ) of the maximum αₘₐₓ (m⁻¹) to the minimum αₘᵢₙ (m⁻¹) of the absorption index of light in the range of wavelengths 400 to 700 nm is 10 or less. Here, the absorption index of light in the range of wavelengths 400 to 700 nm is adopted as a determination indicator because the range covers the wavelengths of the light of the three colors of R (red), G (green), and B (blue). Accordingly, light absorption is insignificant for the three colors of R (red), G (green), and B (blue), which are used as the light source of a liquid crystal television whose surface-shaped light-emitting device is of the edge-lit type, and the difference of absorption of the light in the range of 400-700-nm wavelengths is also insignificant. It is more preferable that (αₘₐₓ/αₘᵢₙ) is 9 or less, 8 or less, 7 or less, 6 or less, 5 or less, 4 or less, 3 or less, 2 or less, and 1 or less.

<Glass Composition>

A raw material of glass includes Fe₂O₃ as unavoidable impurities. It is difficult in practice to reduce Fe₂O₃ in a raw material for glass to a level at which optical absorption inside the glass in the visible light region (wavelengths of 380 to 780 nm) does not matter. The glass sheet in the embodiment contains total iron oxide (t-Fe₂O₃) by 1 to 500 mass ppm converted into Fe₂O₃.

It is preferable that the ferrous (Fe²⁺) content converted into Fe₂O₃ of the glass sheet in the embodiment is 0 to 50 ppm. If the ferrous (Fe²⁺) content converted into Fe₂O₃ is within the above range, the optical absorption inside the glass in the visible light region (wavelengths of 380 to 780 nm) does not matter when used as a light-guiding plate part of an edge-lit, liquid crystal television. It is preferable that the ferrous (Fe²⁺) content converted into Fe₂O₃ is 0 to 40 mass ppm, more preferable to be 0 to 30 mass ppm, and particularly preferable to be 0 to 25 mass ppm.

The redox of the glass sheet in the embodiment ([ferrous (Fe²⁺) converted into Fe₂O₃]/[sum(Fe²⁺+Fe³⁺) of ferrous (Fe²⁺) and ferric (Fe³⁺) converted into Fe₂O₃]) is greater than equal to 0% and less than equal to 25%. As long as the redox is within the above range, the optical absorption inside the glass in the visible light region (wavelength of 380-780 nm) does not matter when used as a light-guiding plate part of an edge-lit, liquid crystal television. It is preferable that the redox is 0 to 22%, more preferable to be 0 to 20%, and particularly preferable to be 0 to 18%.

The glass composition of the glass sheet in the embodiment is not limited particularly, and, for example, the following glass compositions may be considered.

(i) Glass containing: 50 to 81 mass % SiO₂; 1 to 10 mass % Al₂O₃; 0 to 5 mass % B₂O₃; 5 to 15 mass % Li₂O+Na₂O+K₂O; 13 to 27 mass % MgO+CaO+SrO+BaO; 1 to 500 mass ppm of total iron oxide (t-Fe₂O₃) converted into Fe₂O₃; and 0 to 25% redox.
(ii) Glass containing: 60 to 80 mass % SiO₂; 0 to 7 mass % Al₂O₃; 0 to 10 mass % MgO; 4 to 20 mass % CaO; 7 to 20 mass % Na₂O; 0 to 10 mass % K₂O; 1 to 500 mass ppm of total iron oxide (t-Fe₂O₃) converted into Fe₂O₃; and 0 to 25% redox.
(iii) Glass containing: 45 to 80 mass % SiO₂; 7 to 30 mass % or less Al₂O₃; 0 to 15 mass % B₂O₃; 0 to 15 mass % MgO; 0 to 6 mass % CaO; 7 to 20 mass % Na₂O; 0 to 10 mass % K₂O; 0 to 10 mass % ZrO₂; 1 to 500 mass ppm of total iron oxide (t-Fe₂O₃) converted into Fe₂O₃; and 0 to 25% redox.
(iv) Glass containing: 45 to 70 mass % SiO₂; 10 to 30 mass % Al₂O₃; 0 to 15 mass % B₂O₃; 5 to 30 mass % of at least one substance chosen from a group consisting of MgO, CaO, SrO, and BaO; 0 to 7 mass % of at least one substance chosen from a group consisting of Li₂O, Na₂O, and K₂O; 1 to 500 mass ppm of total iron oxide (t-Fe₂O₃) converted into Fe₂O₃; and 0 to 25% redox.

<Method for Manufacturing Glass Sheet>

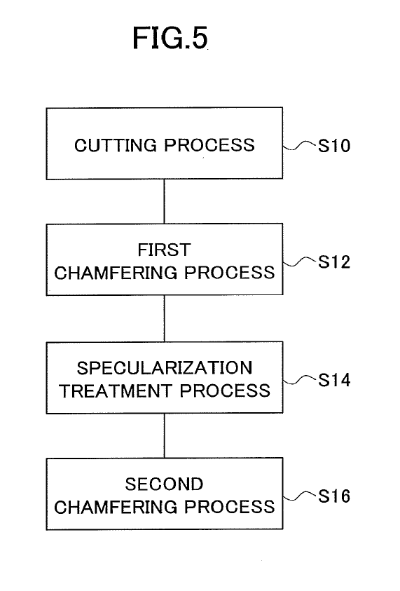

Next, a method for manufacturing a glass sheet to be served as the light-guiding plate 5 will be described. FIG. 5 to FIG. 7 are diagrams for illustrating a method for manufacturing a glass sheet to be served as the light-guiding plate 5. FIG. 5 is a process chart illustrating a method for manufacturing glass sheet to be served as the light-guiding plate 5.

In order to manufacture the light-guiding plate 5, a glass material 12 is provided first. As described above, it is preferable that this glass has the absorption index of light having the wavelength of 550 nm being 1 m⁻¹ or less, and the ratio (αₘₐₓ/αₘᵢₙ) of the maximum αₘₐₓ (m⁻¹) to the minimum αₘᵢₙ (m⁻¹) of the absorption index of light in the range of wavelengths 400 to 700 nm being 10 or less. This glass material 12 is set to have a shape greater than a predetermined shape of the light-guiding plate 5.

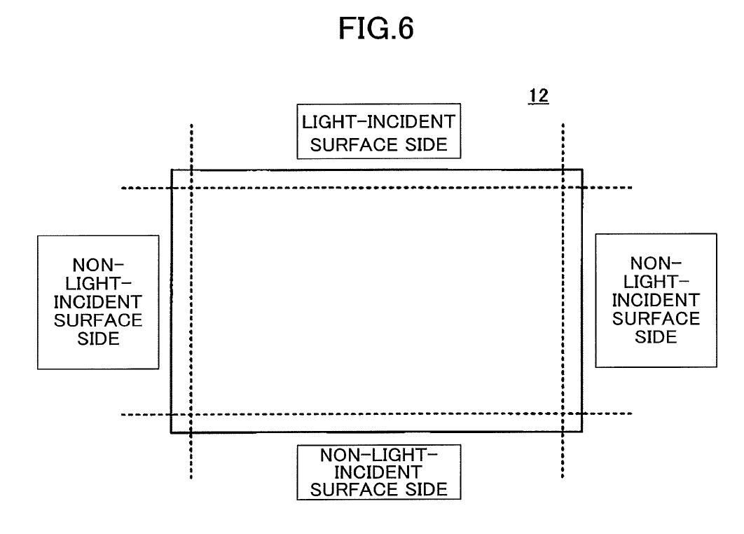

First, a cutting process at Step 10 illustrated in FIG. 5 is applied to the glass material 12 (in the figure, “Step” is abbreviated as “S”). In the cutting process, cutting is executed at positions illustrated with dashed lines in FIG. 6 (one position on the side of the light-incident edge surface, and three positions on the sides of the non-light-incident edge surfaces), by using a cutting device. Although the cutting may be executed at any of the positions illustrated with the dashed lines, from the viewpoint of productivity improvement, the cutting may not necessarily be executed at the three positions on the sides of the non-light-incident edge surfaces, and the cutting may be executed at only one position on the side of the non-light-incident edge surface facing the one position on the side of the light-incident edge surface.

By executing the cutting, a glass base material 14 is cut from the glass material 12. Note that in the embodiment, since the light-guiding plate 5 is set to have a rectangular shape in a planar view, the cutting is executed at the one position on the side of the light-incident edge surface, and the three positions on the sides of the non-light-incident edge surfaces. However, the cutting positions may be selected appropriately depending on the shape of the light-guiding plate 5.

Having completed the cutting, a first chamfering process is executed (Step 12). In the first chamfering process, by using a grinding device, chamfer surfaces on the non-light-incident side 58 are formed both between the light-emitting surface 51 and the non-light-incident edge surface 56, and between the light-reflective surface 52 and the non-light-incident edge surface 56.

Note that if the chamfer surface on the non-light-incident side 58 is formed at each of, or one of the locations between the light-emitting surface 51 and the non-light-incident edge surface 54; between the light-reflective surface 52 and the non-light-incident edge surface 54; between the light-emitting surface 51 and the non-light-incident edge surface 55; and between the light-reflective surface 52 and the non-light-incident edge surface 55, chamfering is executed in this first chamfering process.

Besides, in this first chamfering process, chamfering may be executed at both of, or one of the locations between the light-emitting surface 51 and the light-incident edge surface 53, and between the light-reflective surface 52 and the light-incident edge surface 53, to form the chamfer surface on the light-incident side.

Also, in the embodiment, in the first chamfering process, a grinding process or a polishing process is applied to the non-light-incident edge surfaces 54-56 and the light-incident edge surface 53. The grinding process or the polishing process may be applied to the non-light-incident edge surfaces 54-56 and the light-incident edge surface 53, before or after forming the chamfer surfaces on the non-light-incident side 58 and the chamfer surface on the light-incident side described above, or may be applied at the same time. Note that as for the non-light-incident edge surfaces 54-56, the surfaces to which the cutting has been applied may be served as the non-light-incident edge surfaces 54-56 as they are. Also, as for light-incident edge surface 53, as long as Formula (1) in the embodiment is satisfied, the surface to which the cutting has been applied may be served as light-incident edge surface 53 as it is.

Although the first chamfering process (Step 12) may be executed simultaneously with a specularization treatment process (Step 14) and a second chamfering process (Step 16), which will be described later, or may be executed after these processes, it is preferable to execute Step 12 before Steps 14 and 16. This enables to execute processing that depends on the shape of the light-guiding plate 5 at Step 12 at a comparatively fast rate, and thereby, to improve the productivity, and to make the light-incident edge surface 53 and the chamfer surface on the light-incident side 57 less likely to be damaged by comparatively large cullet generated at Step 12. If the surfaces to which the cutting has been applied are served as the non-light-incident edge surfaces 54-56 and the light-incident edge surface 53 as they are, it is not necessary to execute the specularization treatment process (Step 14), which will be described later.

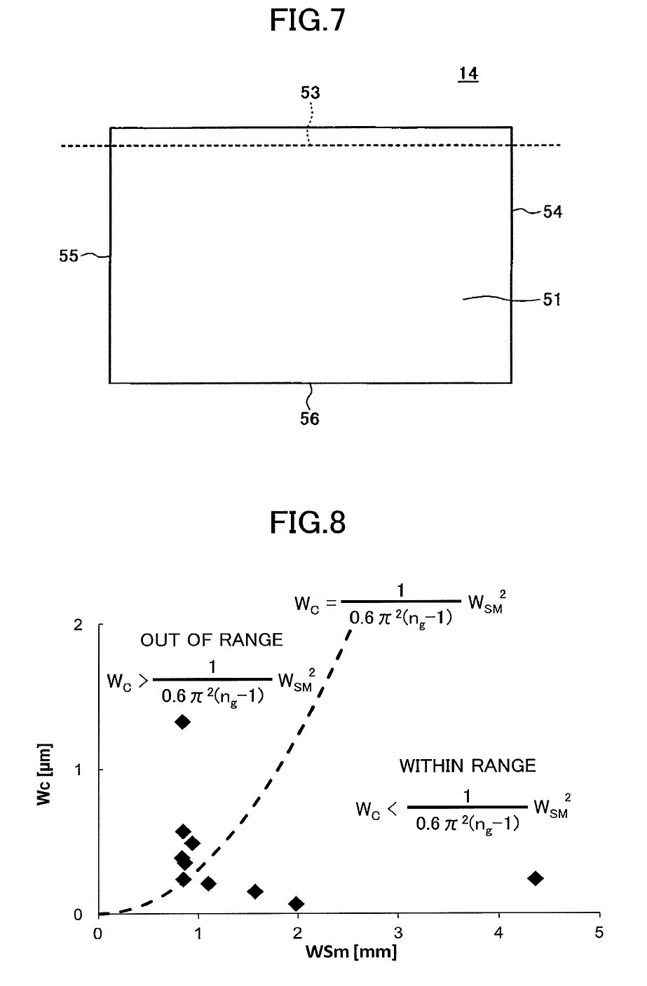

Once the first chamfering process (Step 12) has been completed, the specularization treatment process is executed next (Step 14). In this specularization treatment process, as illustrated in FIG. 7, specularization treatment is applied to the glass base material 14 on the side of the light-incident edge surface, to form the light-incident edge surface 53. As described above, the light-incident edge surface 53 is a surface on which the light from the light source 4 is incident. Therefore, it is preferable to apply specularization treatment to the light-incident edge surface 53 so that the arithmetic mean waviness Wa becomes 0.2 μm or less. Also, it is preferable that the shape of the power spectrum of the periodic structure of the light-incident edge surface 53 has the maximum peak position Sₚ less than 1 mm⁻¹ within a range of the spatial frequency being 0.01 to 10 mm⁻¹. Furthermore, it is preferable that the specularization treatment is executed so that the arithmetic mean roughness Ra of the light-incident edge surface 53 becomes 0.03 μm or less.

At this time, it is possible to execute the specularization treatment so that the arithmetic mean roughness Ra of the light-incident edge surface 53, the mean height Wc of the waviness profile element, the mean length WSm of the waviness profile element, the arithmetic mean waviness Wa, and the maximum height Pz of the cross-sectional profile are controlled respectively and independently. For example, by changing the sweeping speed of a polishing jig in the specularization treatment, it is possible to increase or decrease the value of the mean height Wc of the waviness profile element, the mean length WSm of the waviness profile element, the arithmetic mean waviness Wa, and the maximum height Pz of the cross-sectional profile, without changing the value of arithmetic mean roughness Ra considerably.

Once having the light-incident edge surface 53 formed on the glass base material 14 in the specularization treatment process (Step 14), next, the second chamfering process (Step 16) is executed to form the chamfer surfaces on the light-incident side 57 (chamfer surfaces) by applying a grinding process or a polishing process at locations between the light-emitting surface 51 and the light-incident edge surface 53, and between the light-reflective surface 52 and the light-incident edge surface 53. Note that Step 16 may be executed before Step 14, or may be executed simultaneously with Step 14.

In the second chamfering process, representing the average of the width dimension X of the chamfer surface on the light-incident side 57 in the longitudinal direction by Xₐᵥₑ, it is processed so that an error of X in the longitudinal direction becomes within 50% of Xₐᵥₑ, and the arithmetic mean roughness Ra becomes 0.4 μm or less. When forming these chamfer surfaces on the light-incident side 57, as a tool to execute the grinding process or the polishing process, a whetstone may be used, or other than a whetstone, buff made of cloth, skin, rubber, and the like, or a brush may be used, and at the same time, an abrasive such as cerium oxide, alumina, carborundum, or colloidal silica may be used.

By executing the processes described in the above Steps 10-16, the light-guiding plate 5 is manufactured. Note that the reflective dots 10A-10C are printed on the light-reflective surface 52 after the light-guiding plate 5 has been manufactured.

As above, preferred embodiments of the present invention have been described in detail. Note that the present invention is not limited to the specific embodiments described above, but various variations and modifications may be made within the scope of the present invention described in claims.

### Application Examples

In the following, the present invention will be specifically described with application examples. Note that the present invention is not limited by these examples.

In the following experiments 1-3, a glass sheet that includes, by mass percentage, 71.6% SiO₂, 0.97% Al₂O₃, 3.6% MgO, 9.3% CaO, 13.9% Na₂O, 0.05% K₂O, and 0.005% Fe₂O₃, is used as the glass sheet (50 mm long, 50 mm wide, and 2.5 mm thick). The glass sheet was obtained from a glass sheet that was manufactured by a float glass process and cut in the cutting process (upon the cutting, the corner parts of the glass sheet were cut to prevent a crack). The glass sheet has four edge surfaces between the light-emitting surface and the light-reflective surface, and among the four edge surfaces, one edge surface is the light-incident edge surface, and three edge surfaces are the non-light-incident edge surfaces.

After the cutting process, the first chamfering process was executed. In the first chamfering process, the grinding process was applied to the three non-light-incident edge surfaces. Then, by using a polishing device on the light-incident edge surface, the specularization treatment was executed under various conditions. Furthermore, by using a grinding device, chamfering was executed at locations of the glass sheet between the light-emitting surface and the non-light-incident edge surfaces; between the light-reflective surface and the non-light-incident edge surfaces; between the light-emitting surface and the light-incident edge surface; and between the light-reflective surface and the light-incident edge surface.

### Experiment 1

First, in order to confirm that the arithmetic mean roughness Ra of the light-incident edge surface, the mean height Wc of the waviness profile element, the mean length WSm of the waviness profile element, and the arithmetic mean waviness Wa can be controlled respectively and independently, the following experiment was conducted. In this experiment, the specularization treatment was applied to the same glass base material in which the sweeping speed and the number of revolutions of the polishing device (polishing jig) applied to the light-incident edge surface were changed, to produce samples 1-9.

The mean height Wc of the waviness profile element, the mean length WSm of the waviness profile element, and the arithmetic mean waviness Wa of the light-incident edge surface of the light-incident edge surface 53 were measured by using a surface roughness and contour measuring instrument Surfcom 1400D (manufactured by Tokyo Seimitsu Co., Ltd.), to scan the light-incident edge surface under the following measurement conditions.

Cutoff value: λ_{c}=0.25 mm and λ_{f}=2.5 mm
Scanning rate: 0.3 mm/sec
Measurement length: 5λ_{f}

The arithmetic mean roughness Ra of the light-incident edge surface was similarly measured by using the same surface roughness and contour measuring instrument

Surfcom 1400D (manufactured by Tokyo Seimitsu Co., Ltd.), to scan the light-incident edge surface under the following measurement conditions.

Cutoff value: λ_{c}=0.25 mm
Scanning rate: 0.3 mm/sec
Measurement length: 5λ_{c}

Table 1 shows the sweeping speed and the number of revolutions of the polishing device when the samples 1-9 were produced, the mean height We of the waviness profile element, the mean length WSm of the waviness profile element, the arithmetic mean waviness Wa, and the arithmetic mean roughness Ra of the light-incident edge surface.

TABLE 1

| | SWEEPING | NUMBER | Wc | WSm | Wa | Ra |
|---|---|---|---|---|---|---|
| | SPEED | OF REV. | [μm] | [mm] | [μm] | [μm] |
| | [m/min] | [rpm] | AVERAGE | AVERAGE | AVERAGE | AVERAGE |
| SAMPLE | 0.1 | 120 | 0.241 | 0.847 | 0.079 | 0.009 |
| 1 | | | | | | |
| SAMPLE | 0.25 | 300 | 0.571 | 0.843 | 0.184 | 0.008 |
| 2 | | | | | | |
| SAMPLE | 0.15 | 340 | 0.211 | 1.098 | 0.069 | 0.017 |
| 3 | | | | | | |
| SAMPLE | 0.3 | 350 | 0.241 | 4.360 | 0.055 | 0.008 |
| 4 | | | | | | |
| SAMPLE | — | — | 0.389 | 0.832 | 0.097 | 0.008 |
| 5 | | | | | | |
| SAMPLE | — | — | 1.327 | 0.837 | 0.446 | 0.024 |
| 6 | | | | | | |
| SAMPLE | 0.1 | 340 | 0.156 | 1.569 | 0.052 | 0.010 |
| 7 | | | | | | |
| SAMPLE | 0.15 | 350 | 0.070 | 1.981 | 0.016 | 0.008 |
| 8 | | | | | | |
| SAMPLE | — | — | 0.490 | 0.936 | 0.143 | 0.009 |
| 9 | | | | | | |

With respect to the samples 1 and 2, it is understood that the value of the mean height We of the waviness profile element, and the arithmetic mean waviness Wa of the light-incident edge surface could be increased or decreased without changing the value of the mean length WSm of the waviness profile element considerably by controlling values of the sweeping speed and the number of revolutions of the polishing device. The samples 3-9 were also controlled by changing the sweeping speed and the number of revolutions similarly.

### Experiment 2

The following experiment was conducted in order to investigate a relationship between the mean height Wc of the waviness profile element and the mean length WSm of the waviness profile element of the light-incident edge surface, and the non-uniform brightness of the light-emitting surface.

Before the experiment, an optical relationship between the mean height Wc of the waviness profile element and the mean length WSm of the waviness profile element of the light-incident edge surface will be described in principle. First, considering a function f that approximates the waviness profile of the light-incident edge surface by a sinusoidal wave, the curvature radius R at an arbitrary point on the curve of the function f is obtained by the following Formula (2).

$$\frac{1}{R} = \frac{{f}^{″}}{{( 1 + {{f}^{′}}^{2} )}^{\frac{3}{2}}} \qquad ( 2 )$$

Note that f′ in Formula (2) represents a function obtained by differentiating the function f once, and f″ represents a function obtained by differentiating the function f twice. Here, representing the function f by f=A sin(bx), f′=Ab cos(bx) and f″=−Ab² sin(bx) are derived. Also, if using the mean height Wc of the waviness profile element of the light-incident edge surface and the mean length WSm of the waviness profile element, A≈Wc/2 and b≈2π/WSm are satisfied as approximations.

Also, light incident on a point on a curve having the curvature radius R has a focal length L as long as R is a positive real number. At this time, representing the refractive index of the glass sheet by n_{g}, the following Formula (3) is satisfied based on the lens formula. Furthermore, by using Formulas (2) and (3), the following Formula (4) can be derived.

$$\begin{matrix}\frac{1}{L} = ( {n}_{g} - 1 ) \frac{1}{R} & ( 3 ) \\ \frac{1}{L} = ( {n}_{g} - 1 ) \cdot \frac{- {Ab}^{2} sin ( bx )}{{\{ 1 + {( Ab cos ( bx ) )}^{2} \}}^{\frac{3}{2}}} & ( 4 )\end{matrix}$$

With Formula (4), the least focal length L is obtained, namely, light incident on the edge surface comes to the closest focus if bx=3π/2. At this time, representing Formula (4) by using We and WSm, the following Formula (5) is obtained. In Formula (5), if the range satisfies L≧0.3 (m), it is understood that satisfying the above Formula (1) is sufficient.

$${W}_{c} = \frac{1}{2 {π}^{2} L ( {n}_{g} - 1 )} \cdot {WSm}^{2} \qquad ( 5 )$$

Based on the above, the samples 1-9 described in Table 1 were investigated whether to satisfy Formula (1), and the result is illustrated in FIG. 8. The dotted line in FIG. 8 means that both sides of Formula (1) are equivalent, and the area on the dotted line and below the dotted line means the area that satisfies Formula (1). If the glass sheet that satisfies Formula (1) as in the samples 3, 4, 7, and 8 is used as the light-guiding plate, parallel light incident on the light-incident edge surface comes to the focus at the focal length of L=0.3 m or greater; thus, it is possible to inhibit the non-uniform brightness in the surface of the glass sheet as the light-guiding plate. On the other hand, if the glass sheet that does not satisfy Formula (1) as in the samples 1, 2, 5, 6, and 9 is used as the light-guiding plate, parallel light incident on the light-incident edge surface comes to the focus at the focal length of less than L=0.3 m; thus, the non-uniform brightness occurs in the surface of the glass sheet as the light-guiding plate. Therefore, by causing the focus not to have the focal length L of a distance less than 0.3 m, it is possible to inhibit the non-uniform brightness.

It is preferable that the focal length L satisfies (m), and is more preferable to satisfy L≧0.5 (m), 0.6 (m), 0.7 (m), 0.8 (m), 0.9 (m), and 1.0 (m). In other words, it is preferable that Wc and WSm satisfy the following Formula (6) with L=0.3 (m), and more preferable to satisfy the following Formula (6) with L=0.5 (m), 0.6 (m), 0.7 (m), 0.8 (m), 0.9 (m), and 1.0 (m). Accordingly, it is possible to cause the focus not to have a longer distance from the light-incident edge surface, and to further inhibit the non-uniform brightness.

$${W}_{c} ≦ \frac{1}{2 {π}^{2} L ( {n}_{g} - 1 )} \cdot {WSm}^{2} \qquad ( 6 )$$

In order to investigate the validity of Formula (1), the samples 1-9 were combined with an LED light source to serve as a surface-shaped light-emitting device, and images were obtained by using software called Eyscale-3W (manufactured by the i-System Co., Ltd.), to measure the brightness distribution in the surface when using the glass sheets of the samples 1-9 as the light-guiding plate.

The result is shown in Table 2. For the samples 3, 4, 7, and 8, Wc and WSm satisfied Formula (1), and the difference between the maximum and the minimum of the brightness in the brightness distribution was less than 1% of the average, and thus, the non-uniform brightness was practically inhibited. On the other hand, for the samples 1, 2, 5, 6, and 9, Wc and WSm did not satisfy Formula (1), and the difference between the maximum and the minimum of the brightness in the brightness distribution was greater than or equal to 1% of the average, and thus, non-uniform brightness occurred. Therefore, it is understood that Wc and WSm of the light-incident edge surface need to satisfy Formula (1) in order to inhibit the non-uniform brightness.

TABLE 2

| | | | | | | BRIGHT- |
|---|---|---|---|---|---|---|
| | Wc | WSm | | | | NESS NON- |
| | [μm] | [mm] | FORMULA | Sₚ | Iₛ/Iₚ | UNIFORM- |
| | AVERAGE | AVERAGE | (1) | [mm⁻¹] | [—] | ITY |
| SAMPLE | 0.241 | 0.847 | OUT OF | 1.20 | 100% | GENERATED |
| 1 | | | RANGE | | | |
| SAMPLE | 0.571 | 0.843 | OUT OF | 1.20 | 100% | GENERATED |
| 2 | | | RANGE | | | |
| SAMPLE | 0.211 | 1.098 | WITHIN | 0.16 | 66.5% | NEARLY |
| 3 | | | RANGE | | | PREVENTED |
| SAMPLE | 0.241 | 4.360 | WITHIN | 0.24 | 15.0% | PREVENTED |
| 4 | | | RANGE | | | |
| SAMPLE | 0.389 | 0.832 | OUT OF | 1.20 | 100% | GENERATED |
| 5 | | | RANGE | | | |
| SAMPLE | 1.327 | 0.837 | OUT OF | 1.20 | 100% | GENERATED |
| 6 | | | RANGE | | | |
| SAMPLE | 0.156 | 1.569 | WITHIN | 0.16 | 10.7% | PREVENTED |
| 7 | | | RANGE | | | |
| SAMPLE | 0.070 | 1.981 | WI THIN | 0.48 | 45.8% | PREVENTED |
| 8 | | | RANGE | | | |
| SAMPLE | 0.490 | 0.936 | OUT OF | 5.84 | 100% | GENERATED |
| 9 | | | RANGE | | | |

### Experiment 3

Next, the power spectrum of the light-incident edge surface was investigated for the samples 1-9.

It is possible to measure the shape of the power spectrum of the periodic structure of the light-incident edge surface 53 by using Surfcom 1400D (manufactured by Tokyo Seimitsu Co., Ltd.), to scan the light-incident edge surface 53 under the following measurement conditions.

Cutoff value: λₓ=0.25 mm and λ_{f}=2.5 mm
Scanning rate: 0.3 mm/sec
Measurement length: 5λ_{f}

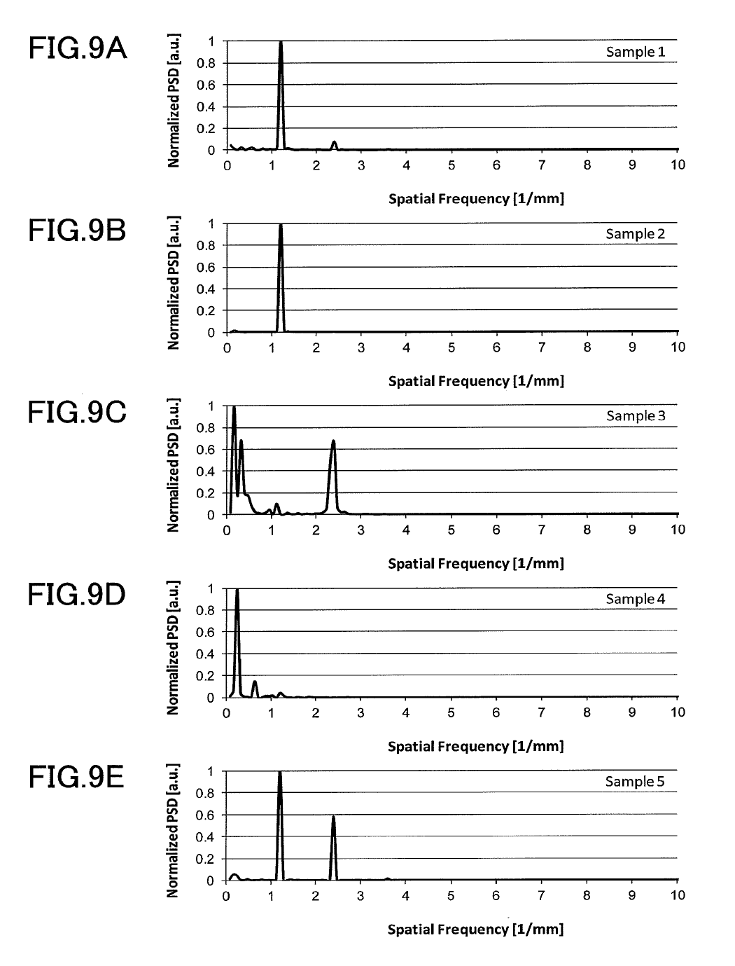

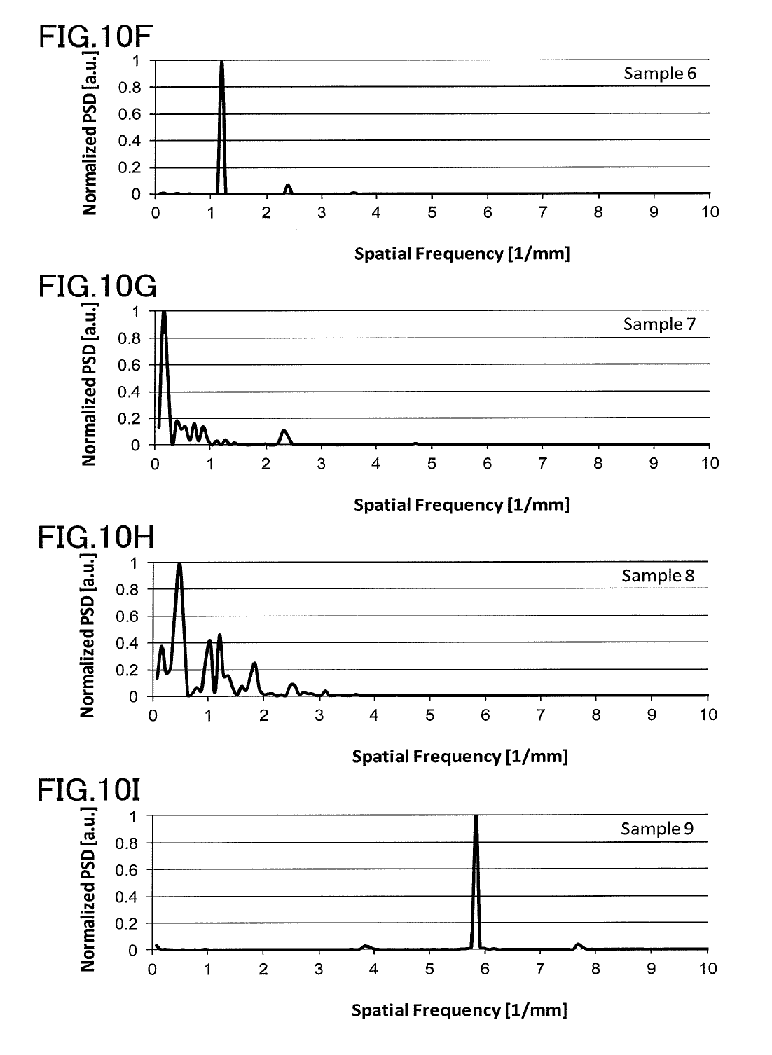

As illustrated in FIGS. 9A to 10I, the shape of the power spectrum of the periodic structure of the light-incident edge surface of the sample 3, 4, 7, or 8 exhibited the maximum peak position Sₚ less than 1 mm⁻¹ within a range of the spatial frequency being 0.01 to 10 mm⁻¹. For these samples, the difference between the maximum and the minimum of the brightness in the brightness distribution was less than 1% of the average, and thus, the non-uniform brightness was practically inhibited.

Also, the ratio Iₛ/Iₚ of the maximum peak intensity Iₛ within a range of the spatial frequency being 1 to 10 mm⁻¹, to the peak intensity Iₚ at the maximum peak position Sₚ, was 50% or less. For these samples, the non-uniform brightness was particularly inhibited.

On the other hand, the shape of the power spectrum of the periodic structure of the light-incident edge surface of the sample 1, 2, 5, 6, or 9 exhibited the maximum peak position Sₚ greater than or equal to 1 mm⁻¹ within the range of the spatial frequency being 0.01 to 10 mm⁻¹. For these samples, the difference between the maximum and the minimum of the brightness in the brightness distribution was greater than or equal to 1% of the average, and the non-uniform brightness occurred.

Therefore, there is a strong correlation between the brightness distribution and the shape of the power spectrum, and it is understood that by controlling the maximum peak position Sₚ within the range of the spatial frequency being 0.01 to 10 mm⁻¹, and the maximum peak intensity Iₛ within a range of the spatial frequency being 1 to 10 mm⁻¹, it is possible to inhibit the non-uniform brightness of the light incident on the light-guiding plate from the light source.

As above, preferred embodiments and application examples of the present invention have been described in detail. Note that the present invention is not limited to the specific embodiments and application examples described above, but various variations and modifications may be made within the scope of the present invention described in claims.

1. A glass sheet comprising:
a first surface;
a second surface facing the first surface; and
at least one first edge surface disposed between the first surface and the second surface,
wherein a mean height We of a waviness profile element of the first edge surface and a mean length WSm of the waviness profile element satisfy Formula (1) below.
$${W}_{c} ≦ \frac{1}{0.6 {π}^{2} ( {n}_{g} - 1 )} \cdot {WSm}^{2} \qquad ( 1 )$$
where n_{g} represents a refractive index of the glass sheet.

2. A glass sheet comprising:
a first surface;
a second surface facing the first surface; and
at least one first edge surface disposed between the first surface and the second surface,
wherein representing a periodic structure of the first edge surface by a power spectrum distribution, a shape of the power spectrum has a maximum peak position Sₚ less than 1 mm⁻¹ within a range of a spatial frequency being 0.01 to 10 mm⁻¹.

3. The glass sheet as claimed in claim 2, wherein the shape of the power spectrum has a ratio Iₛ/Iₚ of a maximum peak intensity Iₛ within a range of the spatial frequency being 1 to 10 mm⁻¹, to a peak intensity Iₚ at the maximum peak position Sₚ, being 50% or less.

4. The glass sheet as claimed in claim 1, wherein an arithmetic mean waviness Wa of the waviness profile of the first edge surface is 0.2 μm or less.

5. The glass sheet as claimed in claim 2, wherein an arithmetic mean waviness Wa of the waviness profile of the first edge surface is 0.2 μm or less.

6. The glass sheet as claimed in claim 3, wherein an arithmetic mean waviness Wa of the waviness profile of the first edge surface is 0.2 μm or less.

7. The glass sheet as claimed in claim 1, wherein an average internal transmittance of a 50-mm length for wavelengths of 400-700 nm is 90% or greater.

8. The glass sheet as claimed in claim 2, wherein an average internal transmittance of a 50-mm length for wavelengths of 400-700 nm is 90% or greater.

9. The glass sheet as claimed in claim 3, wherein an average internal transmittance of a 50-mm length for wavelengths of 400-700 nm is 90% or greater.

10. The glass sheet as claimed in claim 4, wherein an average internal transmittance of a 50-mm length for wavelengths of 400-700 nm is 90% or greater.

11. The glass sheet as claimed in claim 5, wherein an average internal transmittance of a 50-mm length for wavelengths of 400-700 nm is 90% or greater.

12. The glass sheet as claimed in claim 6, wherein an average internal transmittance of a 50-mm length for wavelengths of 400-700 nm is 90% or greater.

13. A method for manufacturing a glass sheet, the method comprising:
a cutting process for forming a glass material, in which the glass material is cut to have a first surface, at least one second surface facing the first surface, at least one first edge surface and at least one second edge surface disposed between the first surface and the second surface,
wherein a mean height We of a waviness profile element of the first edge surface and a mean length WSm of the waviness profile element satisfy Formula (1) below.
$${W}_{c} ≦ \frac{1}{0.6 {π}^{2} ( {n}_{g} - 1 )} \cdot {WSm}^{2} \qquad ( 1 )$$
where n_{g} represents a refractive index of the glass sheet.
